(19) United States
(12) Patent Application Publication
(10) Pub. No.: US 2006/0173924 A1
(43) Pub. Date: Aug. 3, 2006

(54) Calculating the quality of a data record

(76) Inventors: Malcolm Wotton, Bushey (GB); Goran Vuckovic, North Station Colchester (GB)

Correspondence Address: CHAPIN & HUANG L.L.C.;WESTBOROUGH OFFICE PARK, 1700 WEST PARK DRIVE, WESTBOROUGH, MA, 01581, US

(21) Appl. No.: 11/268,685

(22) Filed: Nov. 7, 2005

(30) Foreign Application Priority Data
Nov. 9, 2004 (GB) 0424723.5

(51) Int. Cl. G06F 17/30

(52) U.S. Cl. 707/200

(57) ABSTRACT

A method of calculating the quality of a data record having a plurality of data fields involves identifying individual fields in the data record that are incorrect and scoring those fields accordingly. Further fields are identified where any one or more of those fields may be incorrect, but it is not immediately possible to determine which one or ones. These further fields are also scored accordingly. A score for the data record as a whole is then calculated based on the scores assigned to individual fields. Different fields may be weighted according to their importance to the data record as a whole.

### CROSS REFERENCE TO RELATED APPLICATIONS

This patent application claims priority to GB Patent Application No. 0424723.5 filed on Nov. 9, 2004, entitled, “CALCULATING THE QUALITY OF A DATA RECORD”, the contents and teachings of which are hereby incorporated by reference in their entirety.

### BACKGROUND

The present invention relates generally to the field of data quality control. More specifically, the present invention relates to methods, computer implemented methods, computer systems and computer programs for quantifying or calculating the quality of a data record.

In a data rich world, having high quality data records is important. People and organisations rely on data when making personal and business decisions, and any flaws in the data may lead to a wrong decision. The person responsible for maintaining the data might then be held accountable for bad decisions made on the basis of that data. There is therefore a continuing need to develop better methods and processes for ensuring that data is of as high a quality as possible. As part of this, there is a need to determine the accuracy of a data record and to assign a score to the data record accordingly. In effect, the quality of a data record should be quantifiable.

One method of quantifying data quality deficiencies in very large databases is described in the paper “Data Quality Mining (DQM)—Making a Virtue of Necessity” by Hipp, Guntzer and Grimmer, available on the Internet at www.cs.cornell.edu/johannes/papers/dmkd2001-papers/p5_hipp.pdf. The DQM paper suggests creating association rules based on the contents of a database. Each association rule is an implication that if a data record contains a particular item, then there is a specified probability or confidence value that data record also contains another, associated item. If a data record contradicts an association rule, then this data record might be suspected of deficiencies, but this is not necessarily a sign of incorrectness, since the data record might simply be an unusual case.

### SUMMARY

In the conventional system described above, the association rules do not perform any check as to whether the data in the database is correct, only whether the data record exhibits relationships between items that are common throughout the database as a whole. This conventional method is therefore of limited use when assessing the quality of data records where a degree of certainty is desired.

A first aspect of the present invention provides a method of quantifying the quality of a data record, the data record comprising a plurality of fields, the method comprising: applying at least one critical rule to the data record, the or each critical rule to identify an individual field that is incorrect; assigning a field score to the or each identified individual field; applying at least one regular rule to the data record, the or each regular rule to identify a group of at least two fields where at least one field in the group is incorrect; assigning a field score to any previously un-scored fields based upon whether the previously un-scored field is in an identified group of fields. The first aspect of the present invention therefore provides a two stage process for identifying errors in the data record and for assigning a score to each field in the data record accordingly, thereby quantifying the quality of the data record.

Preferably, the method further comprises assigning a record score to the data record based upon the field scores, for example by calculating a weighted average of the field scores. In this way, embodiments of the present invention can also calculate a score for the entire data record to directly indicate the quality of the data record overall.

Preferably, the field score assigned to the or each identified individual field is a minimum score. Also, the field score assigned to a previously un-scored field that is not in an identified group of fields is preferably a maximum score. In one embodiment, the minimum score is zero while the maximum score is one. However, in other embodiments, the score is a percentage, with 0% being the minimum score and 100% being the maximum score, or the score may run between any two numbers. The score may also be inverted such that the higher number is the minimum score. For example, in one embodiment, the minimum score is one, while the maximum score is zero.

Preferably, each regular rule is assigned a weight and the field score assigned to a previously un-scored field that is in an identified group of fields is based on the weights of the regular rules applied to that field. In this embodiment, different regular rules may be weighted according to the relative importance of the regular rule to the overall quality of the data record.

In one embodiment, the data record contains financial data such as financial market data or security data. In another embodiment the data record contains technical data such as image data and the method may be used to check the quality of the image data. Other types of data, such as address or contact information, for example, may be contained in the data record.

In a second aspect, the present invention provides a method of assigning a score to a data record, the data record comprising a plurality of fields, the method comprising: identifying at least one individual field that is incorrect; assigning a score to the or each identified individual field; in the un-scored fields, identifying at least one group of fields where the or each group comprises a plurality of fields of which at least one is incorrect; calculating a score for each previously un-scored field based upon whether the previously un-scored field is in an identified group of fields; and calculating a score for the data record based upon the scores assigned to each field. Advantages of this second aspect of the present invention will be clear from the above discussion of the first aspect.

Preferably, the at least one individual field is identified as incorrect without reference to other fields in the data record. In this first stage of identifying errors in the data record, there is certainty that an error in an individual field is in that field rather than in any other field in the data record. Also preferably, the or each group of fields comprises a plurality of fields that are inconsistent with one another such that at least one of fields is incorrect, but where it is not possible to determine which of the plurality of fields is incorrect. This represents a second stage to identifying errors in the data record where an incompatibility between data records is identified. By applying appropriate scores in each of the two stages according to identified errors, it is possible to develop a useful picture of the overall quality of the data record.

In a third aspect, the present invention provides a method of quantifying the quality of a data record comprising a plurality of fields, each field for containing a data item, the method comprising: applying at least one plural rule to the data record and recording a result, the or each plural rule being applied to a plurality of fields and failure of a plural rule indicating with certainty that at least one of the data items in the fields to which that plural rule has been applied is incorrect; calculating a record score for the data record based upon the result of applying the or each plural rule to the data record, the record score indicating the quality of the data record. This third aspect of the present invention assigns scores to a data record following a review of the fields in the data record which brings to light errors in the fields.

Preferably, the method further comprises, before applying the or each plural rule, applying at least one singular rule to the data record and recording a result, the or each singular rule being applied to a single field and failure of a singular rule meaning that a data item in the field to which that singular rule has been applied is incorrect, and wherein the record score is additionally based on the results of applying the or each singular rule to the data record. This again brings in a two stage process to the method of identifying errors in a data record and for assigning a score to the data record accordingly.

Preferably, the or each plural rule defines a condition that should be true when comparing values of the data items in the plurality of fields to which the plural rule is applied. For example, the condition in one embodiment is that a value of a data item in one field should be greater than a value of a data item in another field. Of course, this relationship may be defined in terms of one data item being less than another in order to have the same effect.

Each of the above three aspect of the present invention may be embodied on a computer program product. The computer program product may be stored on a computer readable medium such as a floppy disk, a compact disc, or any suitable ROM or RAM. In one embodiment, the computer program product comprises instructions for a computer to carry out the method of any of the preceding aspects or embodiments of the present invention.

The present invention may also be embodied on a computer or a computer processor arranged to perform the method of any of the preceding aspects or embodiments of the present invention.

In particular a fourth aspect of the present invention provides a computer program product for running on a processor and for causing the processor to calculate a score indicating the quality of a data record, the data record comprising a plurality of fields, the computer program product comprising: code for applying at least one critical rule to the data record, the or each critical rule to identify an individual field that is incorrect; code for assigning a field score to the or each identified individual field; code for applying at least one regular rule to the data record, the or each regular rule to identify a group of at least two fields where at least one field in the group is incorrect; and code for assigning a field score to any previously un-scored fields based upon whether the previously un-scored field is in an identified group of fields. Computer program products similar to this may be used to implement any of the first three aspects of the present invention, and the advantages and preferred features of this fourth aspect will be clear from the preceding discussion of the first three aspects.

In a fifth aspect, the present invention provide a computer system comprising at least one processor arranged to: apply at least one critical rule to the data record in order to identify an individual field that is incorrect; assign a field score to the or each identified individual field; apply at least one regular rule to the data record in order to identify a group of at least two fields where at least one field in the group is incorrect; and assign a field score to any previously un-scored fields based upon whether the previously un-scored field is in an identified group of fields. Again, computer systems similar to this may be used to implement any of the first three aspects of the present invention, and the advantages and preferred features of this fifth aspect of the present invention will be clear from the preceding discussion of the first three aspects.

### BRIEF DESCRIPTION OF DRAWINGS

A preferred embodiment of the present invention will now be described by way of an example only and with reference to the accompanying drawings in which:

FIG. 1 is a flow chart illustrating the steps of a method for quantifying the quality of a data record;

FIG. 2 is an example table of data records to which a method embodying the present invention may be applied;

FIG. 3 is an example table of weights assigned to each field in the data records of FIG. 2;

FIG. 4 is an example rules table recording information about rules to be applied to the data records of FIG. 2;

FIG. 5 is a first example results table of data records showing the results of applying a first set of rules to the data records of FIG. 2;

FIG. 6 is a second example results table showing the results of applying a second set of rules to the data records of FIG. 5;

FIG. 7 is an example table of field scores calculated using the results table of FIG. 6;

FIG. 8 is an example table of record scores calculated using the table of FIG. 7 and indicating the quality of each of the data records of FIG. 2; and

FIG. 9 illustrates a system capable of carrying out a method embodying the present invention.

### DETAILED DESCRIPTION

Embodiments of the present invention are used to calculate a score indicating the quality of a data record, thereby quantifying that quality.

By data record is meant any set or array of data. The data may be contained in a database, and the data record being scored may be the entire database or only a part of that database. A data record could also be a single line of data, perhaps indicating a change to a previous condition. As a specific, non-limiting example, a data record could list name and address information for a client of an organisation. Such organisations may have many clients and store name and address information for each of these clients in a database. Embodiments of the present invention could be used to score the quality of any individual client record, or may score the quality of the entire contents of the database. A data record could also relate to financial data, such as financial security static data covering debt and equity instruments, corporate actions and prices. A data record could also be a notification of the change in the price of a share on the stock market, or a summary of the changes to all shares over the course of a day, week, or other time period.

Data records typically comprise two or more fields into which data items can be inserted, usually one data item per field. The data items may be numbers, text strings, alphanumeric strings, or any combination of letters, numbers and other characters. Fields need not contain a data item and may be empty or contain a “Null” character. This may of itself represent an error, or may be acceptable given the nature of the data record. For example, in a data record containing client address information, it may be perfectly acceptable not to have a fax number for a client and to leave the field for receiving the fax number empty or to fill it with a “Null” value.

Embodiments of the present invention may be used to determine a score for any data record where it is possible to create rules to which the data in the data record should adhere. Failure of a rule would indicate an error in the data record. The rules that are used will depend upon the nature of the data. Returning to the above example of an address list, there could be a spell-checking rule which would check the spelling of a country in a client's address against a list of recognised country names. If a field contains a data item stating that a client lives in “The Unted States of Amerca”, that field would fail the spell-checking rule, highlighting that it is incorrect. There could also be a rule that a telephone number must have seven digits. A telephone number of “123456” would fail that rule, again highlighting an error. There could also be rules that compare different fields or entries in a data record and are able to highlight inconsistencies or incompatibilities. For example, a rule could be that the first two letters of a postcode in a client's address must be consistent with the city in that address. Such a rule could be implemented by having a list of cities and a list of valid postcodes associated with each of those cities. A record which states that a client lives in York, but has an SW postcode (for southwest London), would fail such a comparative rule, again highlighting an error. However, from this information alone, it would not be possible to tell which field was incorrect, or even if both of them were incorrect.

From the preceding examples, it can be seen that rules fall into one of two categories. The first category of rule consists of rules which can identify with certainty an error in a field in a data record. The error should be evident from the field without reference to or comparison with any other fields in the data record. Consequently, failure of the rule means that it is definitely the particular field to which the rule has been applied which is incorrect and not any other field in the data record. However, reference may be made to other, trusted data sources and records if desired. Rules in this first category are referred to as singular or critical rules. Singular rules could state, for example, that a data item in a field should be of a particular type (e.g. number; text; alphanumeric), should be within a particular range of values (e.g. less than x; y characters), or should be consistent with or have a specified relationship with a trusted data source (e.g. spelled as in the Oxford English Dictionary; within x % of the mass of a proton as specified in a particular online database).

The second category of rule consists of rules which can identify that there is an error in at least one of two or more fields, but cannot determine which field contains the error. Typically, such rules will identify inconsistencies or incompatibilities between data items in two or more different fields. Rules in this second category are referred to as plural or regular rules. Plural rules could state, for example, that a data item in one field should have a particular relationship to another field (e.g. field 1 is less than field 2; field 1 plus field 2 equals field 3; if field 1 is a number, field 2 is a text string), and that relationship could involve reference to an external trusted source (e.g. if field 1 is York, field 2 has one of the postcodes listed in the Royal Mail index under York).

Advantageously set of rules created to analyse a particular data record may also be applicable to other data records of the same or similar type. For example, in a large database of individual data records, each containing address information for a client, the same rules may well apply to each data record. Different data records containing similarly expressed information about shares or finances may also follow the same rules. This means that one set of rules can be used to check and assign a score to many different data records.

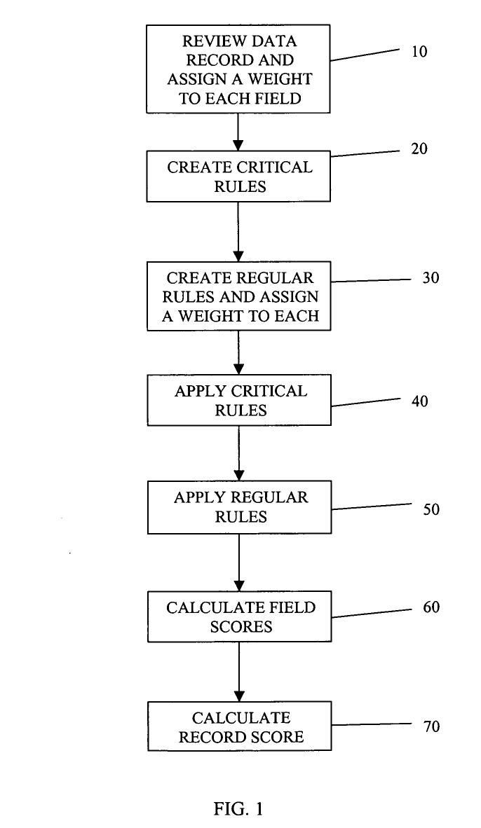

FIG. 1 illustrates the steps in a method embodying the present invention. The first step 10 is to review the data record so that appropriate rules which that data must adhere to can be created. Preferably, a mirror of the data record is created to which the critical and regular rules are applied and in which calculations can be performed to avoid changing the original data record. An example of a mirror for a set of A data records of the same type, each having M fields is given in Table 1 below.

TABLE 1

| Record | Field1 | Field2 | Field3 | . . . | Field M |
|---|---|---|---|---|---|
| 1 | 1.1 | 1.2 | 1.3 | . . . | 1.M |
| 2 | 2.1 | 2.2 | 2.3 | . . . | 2.M |
| 3 | 3.1 | 3.2 | 3.3 | . . . | 3.M |
| . . . | . . . | . . . | . . . | . . . | . . . |
| A | A.1 | A.2 | A.3 | . . . | A.M |

Preferably, the relative importance of each field in the data record to the overall quality of the data record is assessed and an appropriate weight assigned to each field accordingly. The weights will typically be any positive number. During the scoring process to be described below, it will be seen that if a field having a large weight is incorrect it makes a bigger impact to the record score than if a field having a small weight is incorrect. A zero weight may also be assigned to a field, if desired, and that field will be ignored when calculating the score for the data record.

For ease of reference, a table may be created to record the weights that have been assigned to each field. An example of a data record having M fields is given in Table 2 below.

TABLE 2

| Field | Weight |
|---|---|
| Field1 | v₁ |
| Field2 | v₂ |
| Field3 | v₃ |
| Field4 | v₄ |
| . . . | . . . |
| FieldM | v_{M} |

In step 20, appropriate singular or critical rules are created. The nature of these rules will depend upon the data record under analysis and the type of data that it contains. Any suitably skilled person would be able to create appropriate rules for a particular data record.

In step 30 appropriate plural or regular rules are created. Each regular rule is also assigned a weight. The weight is an indicator of how important each regular rule is relative to the other regular rules. The weights will typically be any positive number. During the scoring process to be described below, it will be seen that if a field breaks a regular rule having a large weight it makes a bigger impact to the record score than if a field breaks a regular rule having a small weight. A zero weight may also be assigned to a regular rule, and that regular rule will be ignored when calculating the score for the data record. This allows the different regular rules to be turned on or off as desired.

Once the regular and critical rules have been created, a table can be used to record the details of each rule, the field or fields to which that rule applies, the weight assigned to the rule (if it is a regular rule), and an indicator as to whether the rule is a critical rule. An example of a data record having M fields for which N different rules have been created is given in Table 3 below.

TABLE 3

| Rule | Field1 | Field2 | Field3 | . . . | FieldM | Weight | Critical |
|---|---|---|---|---|---|---|---|
| Rule1 | | Y | Y | . . . | | w₁ | No |
| Rule2 | | | Y | . . . | | | Yes |
| Rule3 | Y | Y | Y | . . . | | w₃ | No |
| Rule4 | | | Y | . . . | Y | w₄ | No |
| Rule5 | | | | . . . | Y | | Yes |
| . . . | . . . | . . . | . . . | . . . | . . . | . . . | . . . |
| RuleN | Y | | Y | . . . | | w_{N} | No |

As is highlighted in the table above, each field preferably has at least one rule which applies to it. However, it may be that rules cannot be created for every field in the data record. In such a situation, it would be preferable for such a field to have a low or zero weight since that field may have errors which cannot be identified, potentially leading to a misleading score for the data record.

In step 40, the critical rules are applied to the data record. In the example table above, the critical rules include Rule 2 and Rule 5. If a critical rule fails, the field to which that critical rule has been applied is assigned a score of zero and the contents of that field in the mirror of the data record are replaced with a “Null” value. A “Null” value may be any specified value which is preferably not present elsewhere in the data record and which can be recognised as meaning that this field should be ignored when subsequently applying the regular rules. In one embodiment, the “Null” value is simply the absence of a data item in the field.

An example mirror of a set of A data records after the critical rules have been applied is illustrated in Table 4 below.

TABLE 4

| Record | Field1 | Field2 | Field3 | . . . | Field M |
|---|---|---|---|---|---|
| 1 | 1.1 | 1.2 | 1.3 | . . . | 1.M |
| 2 | 2.1 | 2.2 | NULL (0) | . . . | 2.M |
| 3 | 3.1 | 3.2 | 2.4 | . . . | NULL (0) |
| . . . | . . . | . . . | . . . | . . . | . . . |
| A | A.1 | A.2 | A.3 | . . . | A.M |

In this example, the second data record has failed Rule 2 (which applies to Field 3), and the third data record has failed Rule 5 (which applies to Field M). The values in these fields have each been replaced with a “Null” value, and the (0) indicates that these fields have been assigned a score of zero.

The method continues in step 50 where the regular rules are applied to the data record. Each regular rule is applied in turn, and a record kept at least of which fields fail a rule, but preferably whether they succeed, fail or give a Null result. A Null result is given for a regular rule which applies to fields which contain a “Null” value is therefore ignored. A Null result may also arise if the regular rules cannot be completed for some reason. For example, the regular rule might expect a field to contain a data item, such that it gives a Null result if a field to which it is applied is empty.

The results of applying the regular rules may be recorded in a table such as in Table 5 illustrated below.

TABLE 5

| Record | Field1 | Field2 | Field3 | . . . | Field M |
|---|---|---|---|---|---|
| 1 | 1.1 | 1.2 | 1.3 | . . . | 1.M |
| Rule1 | | TRUE | TRUE | . . . | |
| Rule3 | TRUE | TRUE | TRUE | . . . | |
| Rule4 | | | TRUE | . . . | TRUE |
| RuleN | TRUE | | TRUE | . . . | |
| 2 | 2.1 | 2.2 | NULL (0) | . . . | 2.M |
| Rule1 | | NULL | NULL | . . . | |
| Rule3 | NULL | NULL | NULL | . . . | |
| Rule4 | | | NULL | . . . | NULL |
| RuleN | NULL | | NULL | . . . | |
| 3 | 3.1 | 3.2 | 3.3 | . . . | NULL (0) |
| Rule1 | | FALSE | FALSE | . . . | |
| Rule3 | TRUE | TRUE | TRUE | . . . | |
| Rule4 | | | NULL | . . . | NULL |
| RuleN | TRUE | | TRUE | . . . | |
| . . . | . . . | . . . | . . . | . . . | . . . |
| A | A.1 | A.2 | A.3 | . . . | A.M |
| Rule1 | | TRUE | TRUE | . . . | |
| Rule3 | FALSE | FALSE | FALSE | . . . | |
| Rule4 | | | TRUE | . . . | TRUE |
| RuleN | FALSE | | FALSE | . . . | |

In the example above, Record 1 has passed all the rules. Record 2 has a “Null” value in Field 3 and, since all of the regular rules apply to Field 3, the regular rules for record 2 all give a Null result. Record 3 has failed Rule 1, and has received a Null result for Rule 4 since that rule applies to Field M which contains a “Null” value. Record A has failed Rule 3 and Rule N.

In step 60, a score is calculated for each field in the data record which has not already been assigned a score of zero by virtue of failing a critical rule. The score for each field is calculated as 1−W_{K}^{F}/W_{K}, where:

W_{K}^{F}=The sum of the weights of failed regular rules applied to the field; and

W_{K}=The sum of the weights of all regular rules applicable to the field.

A regular rule which is ignored and/or gives a Null result is considered to have been passed and the weight of that rule is not added to the sum of failed rule weights W_{K}^{F}, but is included in the total sum of rule weights W_{K}.

If a field has no regular rules which are applicable to it, then both W_{K}^{F} and W_{K} will necessarily be equal to zero, resulting in a score for that field of 1−0/0. Although, mathematically speaking, this is an indeterminate result, such a field is conveniently assigned a score of 1.

The score for each field provides a measure of the quality of the field where 1 is highest quality and 0 is the lowest quality. A score of 1 indicates that all rules applied to that field were successful. A score of 0 indicates that all regular rules applied to that field failed or that at least one critical rule applied to that field failed. From the above formulae, it can be seen how the weight for each rule affects its importance to the overall score. A high weighted rule that fails will lower the quality score more than a lower weighted rule.

When calculating the field scores, a simple summation of values is used. This makes the score a meaningful aggregation of weights and scores.

An example showing how the scores are calculated for each field is given in Table 6 below.

TABLE 6

| Record | Field1 | Field2 | Field3 | . . . | FieldM |
|---|---|---|---|---|---|
| 1 | 1 − | 1 − | 1 − | . . . | 1 − |
| | 0/(w₃ + w_{N}) = 1 | 0/(w₁ + w₃) = 1 | 0/(w₁ + w₃ + w₄ + w_{N}) = 1 | | 0/w₄ = 1 |
| 2 | 1 − | 1 − | 0 | . . . | 1 − |
| | 0/(w₃ + w_{N}) = 1 | 0/(w₁ + w₃) = 1 | from critical | | 0/w₄ = 1 |
| 3 | 1 − | 1 − | 1 − | . . . | 0 |
| | 0/(w₃ + w_{N}) = 1 | w₁/(w₁ + w₃) | w₁/(w₁ + w₃ + w₄ + w_{N}) | | from |
| | | | | | critical |
| . . . | . . . | . . . | . . . | . . . | . . . |
| A | 1 − | 1 − | 1 − | . . . | 1 − |
| | (w₃ + w_{N})/(w₃ + w_{N}) = 0 | w₁/(w₁ + w₃) | (w₃ + w_{N})/(w₁ + w₃ + w₄ + w_{N}) | | 0/w₄ = 1 |

In step 70, the score for the data record is calculated based on the scores for each field in the data record. The score for the data record is calculated as the sum of the weights for each field multiplied by that field's score divided by the sum of the weights for all of the fields in the record. i.e. Σv_{K}S_{K}/Σv_{K}, where v_{K} is the weight of Field K, S_{K} is the score of field K, and the summations are carried out for K from 1 to M (where there are M fields in the data record). The score for the data record is again a simple linear summation that provides a measure of the quality of the record where 1 is the highest quality and 0 is the lowest quality. The weight of each field is used to indicate the importance of the field in the overall quality score for the data record, such that the record score is a weighted average of the individual field scores.

If desired, a score for a set of data records can be calculated based on the score for each data record. This overall score can be calculated as a simple average, or each record may be assigned a weight such that a weighted average score can be calculated.

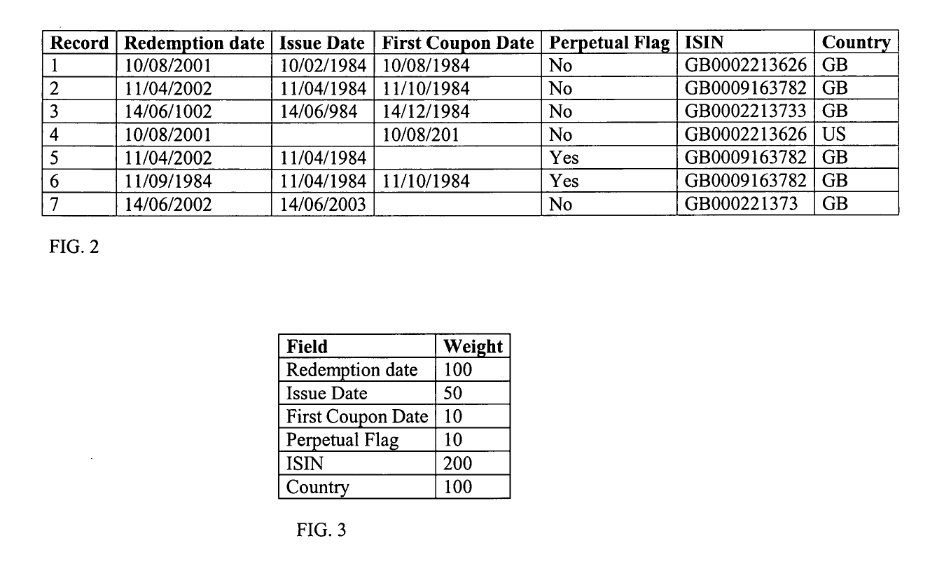

A more specific example of a method of scoring a set of data records will now be described by way of an example only. The data records used in this example are shown in the table of FIG. 2. The weights assigned to each field are shown in the table of FIG. 3. The Redemption Date field has a weight of 100, the Issue Date field has a weight of 50, the First Coupon Date field has a weight of 10, the Perpetual Flag field a weight of 10, the ISIN field a weight of 200, and the country field a weight of 100. The ISIN is therefore considered relatively more important than any other field, whereas the First Coupon Date and Perpetual Flag fields are considered relatively unimportant.

The rules that are applicable to these data records are as follows:

Rule 1. Redemption Date>Issue Date.

Rule 2. Redemption Date>First Coupon Date.

Rule 3. Redemption Date is consistent with Perpetual Flag (True if (Redemption Date is null and Perpetual Flag is on) or if (Redemption Date is non null and Perpetual Flag is off)).

Rule 4. Redemption Date is later than 1 Jan. 1900.

Rule 5. Issue Date is later than 1 Jan. 1900.

Rule 6. First Coupon Date is later than 1 Jan. 1900.

Rule 7. ISIN is 12 characters long.

Rule 8. First two characters of ISIN correspond to Country.

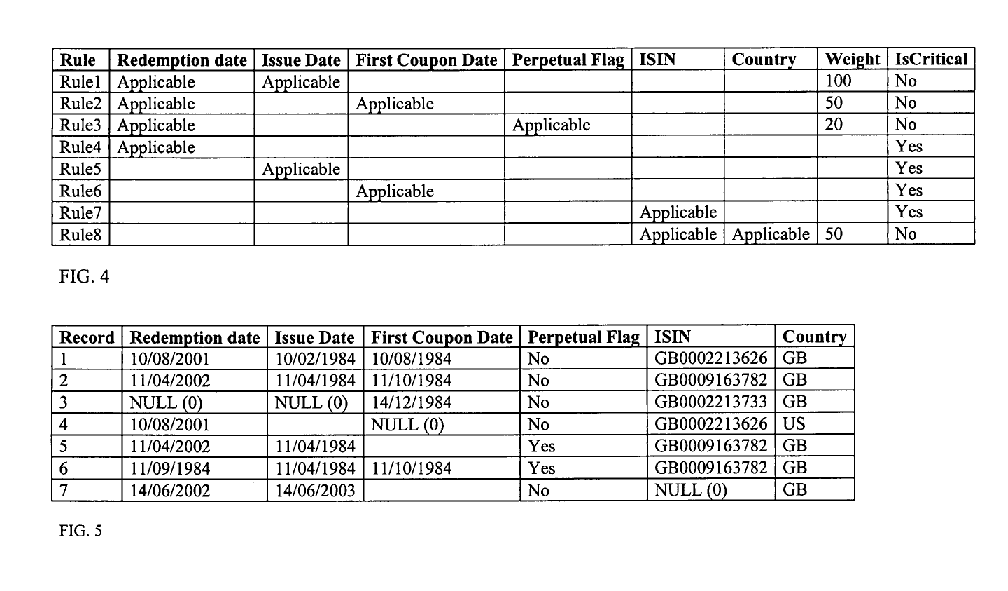

Rules 4, 5, 6 and 7 are critical rules since they require reference to only one field in the data record. The other rules are regular rules since they require a comparison between two different fields in the data record. A rules table, showing which fields each rule is applicable to, the weight for each rule, and whether the rule is a critical rule, is provided in FIG. 4. Rule 1 has a weight of 100, Rule 2 has a weight of 50, Rule 3 has a weight of 20, and Rule 8 has a weight of 50. Rule 1 is therefore considered relatively more important than any other rule, whereas Rule 3 is considered relatively unimportant.

The first step is to apply the critical rules. The results of applying the regular rules are shown in the table of FIG. 5 and are described below.

In Record 3, the Redemption Date field fails Rule 4, and that the Issue Date field fails Rule 5. The First Coupon Date field in Record 4 fails Rule 6. The ISIN field in Record 7 fails Rule 7. Accordingly, a “Null” value is inserted into each of these fields and a score of zero is assigned.

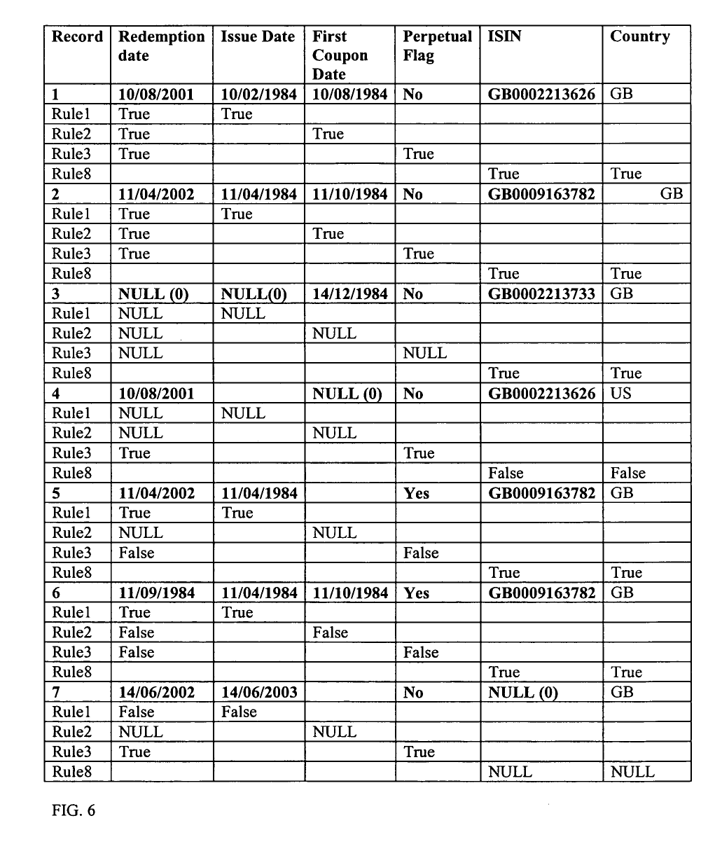

Next, the regular rules are applied. The results of applying the regular rules are shown in the table of FIG. 6 and are described below.

Data records 1 and 2 both pass all of the regular rules.

In data record 3, Rules 1, 2 and 3 all give Null results since the Redemption Date and Issue Date fields contain a “Null” value by virtue of critical Rules 4 and 5. However, Rule 8 is successful.

In data record 4, Rule 1 gives a Null result since the Issue Date field is empty. Rule 2 also gives a Null result since the First Coupon Date field contains a “Null” value by virtue of critical Rule 6. Rule 3 is successfully completed. Rule 8 fails since the first two characters of the ISIN field are “GB” whereas the data item in the Country field is “US”.

In data record 5, Rule 1 is successfully completed. Rule 2 gives a Null result since the First Coupon Date field is empty. Rule 3 fails since the Redemption Date field contains a data item, but the Perpetual Flag field is “Yes”. Rule 8 is successfully completed.

In data record 6, Rule 1 is successfully completed. Rule 2 fails since the Redemption Date is earlier than the First Coupon Date. Rule 3 fails since the Redemption Date field contains a data item, but the Perpetual Flag field is “Yes”. Rule 8 is successfully completed.

In data record 7, Rule 1 fails because the Redemption Date is before the Issue Date. Rule 2 gives a Null result since the First Coupon Date field is empty. Rule 3 is successfully completed. Rule 8 gives a Null result since the ISIN field contains a “Null” value by virtue of critical rule 7.

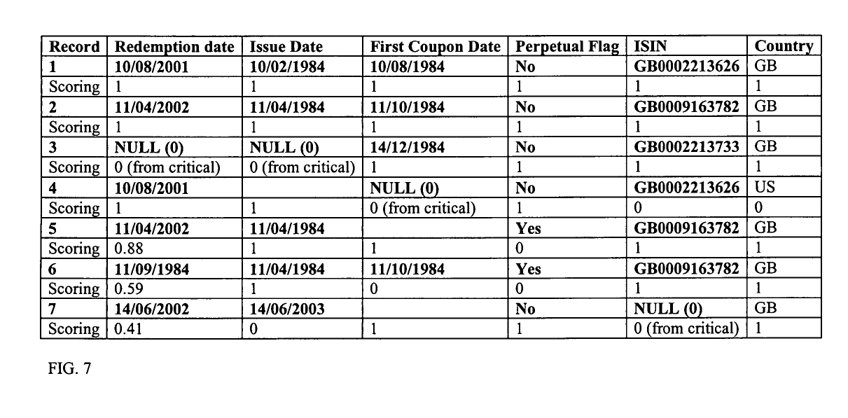

The scores for each field are then calculated. The results of these calculations are shown in the table of FIG. 7 and are described below.

All of the fields in data records 1 and 2 successfully completed every regular and critical rule. Consequently, the field scores are all equal to “1” for these two data records. Explicitly, the Redemption Date field in record 1 receives a score of: 1−0/(100+50+20)=0. Similar calculations are performed for the other fields in records 1 and 2.

The Redemption Date and Issue Date fields in data record 3 have received a score of zero by virtue of critical Rules 4 and 5. However, all of the regular rules were passed, or gave a Null result, such that the other fields in data record 3 receive a score of “1”.

In data record 4, the Redemption Date, Issue Date and Perpetual Flag fields passed all of the regular rules applied to them, or gave a Null result, such that these fields all receive a score of “1”. The First Coupon Date field has received a score of zero by virtue of critical Rule 6. The ISIN and Country fields failed Rule 8 and, since this was the only regular rule applied to these fields, they receive a score of zero. Explicitly, the score for each of these fields is equal to 1−(50/50)=0.

In data record 5, the Redemption Date field passed Rule 1, gave a Null result to Rule 2, and failed Rule 3. Accordingly, the score for this field is equal to 1−20/(100+50+20)=0.88. The Perpetual Flag field failed Rule 3, and since this was the only rule regular applied to this field, it receives a score of zero. The remaining fields either passed their regular rules or gave Null results, such that these fields receive a score of “1”.

In data record 6, the Redemption Date field gave a Null result to Rule 1, but failed Rules 2 and 3. Accordingly, the score for this field is equal to 1−(50+20)/(100+50+20)=0.59. The Issue Date, ISIN and Country fields either passed their regular rules or gave Null results, such that these fields receive a score of “1”. The First Coupon Date and Perpetual Flag fields failed the only regular rule applied to them, such that these fields receive a score of “0”.

In data record 7, the Redemption Date field failed Rule 1, gave a Null result to Rule 2, and passed Rule 3. Accordingly, the score for this field is equal to 1−(100)/(100+50+20)=0.41. It should be noted that this is lower than the score for the same field in record 6 since the weight for Rule 1 is higher than the combined weights of Rules 2 and 3. This illustrates how weights may be used to alter the importance of different rules to the score. The First Coupon Date, Perpetual Flag and Country fields either passed their regular rules or gave Null results, such that these fields are given a score of “1”. The Issue Date field failed the only regular rule applied to it, such that this field is given a score of “0”. The ISIN field has received a score of zero by virtue of critical Rule 7.

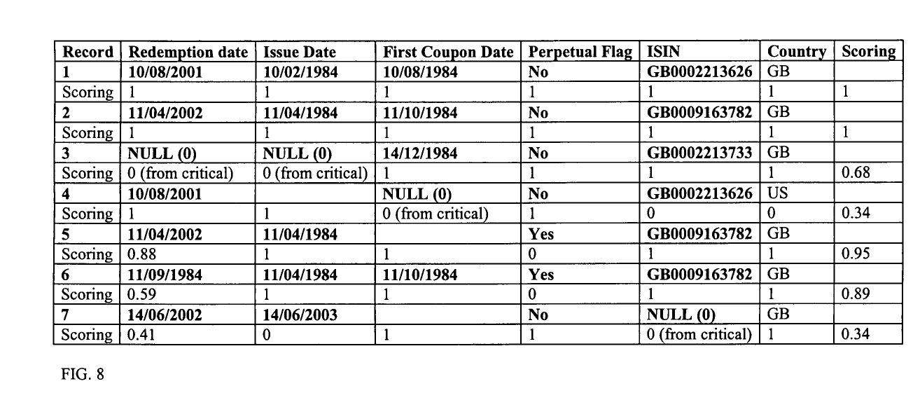

Finally, the score for each record is calculated. The results of these calculations are shown in FIG. 8, and are described below.

Records 1 and 2: Score=(1*100+1*50+1*10+1*10+1*200+1*100)/(100+50+10+10+200+100)=1.

Record 3: Score=(0*100+0*50+1*10+1*10+1*200+1*100)/(100+50+10+10+200+100)=0.68.

Record 4: Score=(1*100+1*50+0*10+1*10+0*200+0*100)/(100+50+10+10+200+100)=0.34. Note that this score is very low since the heavily weighted ISIN field received a score of zero.

Record 5: Score=(0.88*100+1*50+1*10+0*10+1*200+1*100)/(100+50+10+10+200+100)=0.95. Note that this score is still quite high since the Perpetual Flag field only has a small weight and the Redemption Date field only failed one regular rule.

Record 6: Score=(0.59*100+0*50+1*10+1*10+1*200+1*100)/(100+50+10+10+200+100)=0.89.

Record 7: Score=(0.41*100+0*50+1*10+1*10+0*200+1*100)/(100+50+10+10+200+100)=0.34

If desired, a score for the set of seven data records can be calculated. Taking a simple average, this score would be (1+1+0.68+0.34+0.95+0.89+0.34)/7=0.74.

A method embodying the present invention may be implemented in any suitable manner. Preferably, however, the method is implemented on a computer running suitable software and having access to the data to be analysed. A suitable computer may be a typical personal computer, for example, running Microsoft Windows® or any other suitable operating system. However, anything from Personal Digital Assistants or more powerful server computers or distributed computer networks may also be used if desired, and the present invention is not limited in this respect. Suitable software might be any spreadsheet package, such as Microsoft Excel®, which can be programmed with rules for analysing the data in a spreadsheet. However, dedicated software may be written by a person of ordinary skill in the art of software design, and the present invention is again not limited in this respect. The data itself may be stored locally on the computer, may be retrieved over a network such as the Internet, or may be actively sent to the computer from a data source as new data records are generated. Once again, the present invention is not limited in this respect.

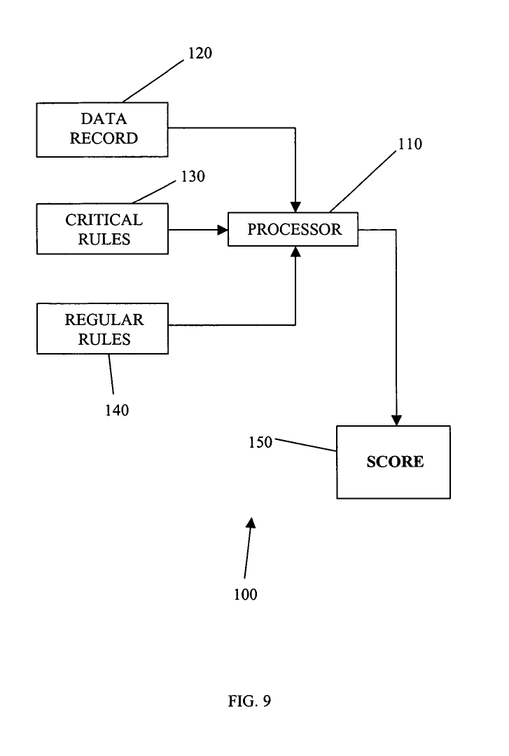

A preferred system 100 for implementing the present invention is illustrated in FIG. 9. The system comprises a processor 110, which may be any suitable processor as mentioned above; a data record store 120, which may be a memory on the same computer as the processor, or may be a remote data store accessible via a network; and a critical rules store 130 and a regular rules store 140, which may again be a memory on the same computer as the processor, or may be a remote data store accessible via a network. The processor 110 receives an input of one or more data records from the data record store 120. The processor 110 then receives one or more critical rules from the critical rules store 130 and applies the critical rules to the received data record as discussed above. The processor 110 then receives one or more regular rules from the regular rules store 140 and applies the regular rules to the received data record as discussed above. Once all of the rules have been applied, a score for the data record is calculated and is outputted 150 in any suitable manner. The output 150 can be to a memory on the same computer as the processor, to a remote memory store, to a display screen for user review, or to any combination of these. The processor 110 itself is preferably running a computer program product embodying the present invention, the computer program product comprising instructions for the processor to apply rules to the received data record and to calculate a score accordingly.

All of the examples provided above are given only to illustrate the wide range of ways in which the present invention may be implemented rather than to define the scope of the invention.

1. A method of quantifying the quality of a data record, the data record comprising a plurality of fields, the method comprising:
applying at least one critical rule to the data record, the or each critical rule to identify an individual field that is incorrect;
assigning a field score to the or each identified individual field;
applying at least one regular rule to the data record, the or each regular rule to identify a group of at least two fields where at least one field in the group is incorrect; and
assigning a field score to any previously un-scored fields based upon whether the previously un-scored field is in an identified group of fields.

2. A method as claimed in claim 1 further comprising assigning a record score to the data record based upon the field scores.

3. A method as claimed in claim 2 wherein each field is assigned a weight and the record score is a weighted average of the field scores.

4. A method as claimed in claim 1 wherein the or each critical rule defines a condition for an individual field, such that if the individual field does not meet that condition, the individual field is incorrect.

5. A method as claimed in claim 1 wherein the field score assigned to the or each identified individual field is a minimum score.

6. A method as claimed in claim 1 wherein the or each regular rule defines a relationship between at least two fields, such that if the at least two fields do not have the defined relationship then at least one of the at least two fields is incorrect.

7. A method as claimed in claim 1 wherein the field score assigned to a previously un-scored field that is not in an identified group of fields is a maximum score.

8. A method as claimed in claim 1 wherein the field score assigned to a previously un-scored field that is in an identified group of fields is based on a number of groups that that field is in.

9. A method as claimed in claim 8 wherein each regular rule is assigned a weight and the field score assigned to a previously un-scored field that is in an identified group of fields is based on the weights of the regular rules applied to that field.

10. A method as claimed in claim 1 wherein each regular rule is assigned a weight and the field score assigned to a previously un-scored field is based on a ratio of the sum of the weights of failed regular rules applied to that field to the sum of the weights of all regular rules applicable to that field.

11. A method as claimed in claim 1 wherein the data record contains financial data.

12. A computer program product comprising instructions which, when run on a processor, causes the processor to carry out a method according to claim 1.

13. A computer system comprising a processor arranged to carry out a method according to claim 1.

14. A method of assigning a score to a data record, the data record comprising a plurality of fields, the method comprising:
identifying at least one individual field that is incorrect;
assigning a score to the or each identified individual field;
in the un-scored fields, identifying at least one group of fields where the or each group comprises a plurality of fields of which at least one is incorrect;
calculating a score for each previously un-scored field based upon whether the previously un-scored field is in an identified group of fields; and
calculating a score for the data record based upon the scores assigned to each field.

15. A method as claimed in claim 14 wherein the at least one individual field is identified as incorrect without reference to other fields in the data record.

16. A method as claimed in claim 14 wherein the at least one individual field identified as incorrect contains an incorrect data item.

17. A method as claimed in claim 14 wherein the score assigned to the or each identified individual field is zero.

18. A method as claimed in claim 14 wherein the or each group of fields comprises a plurality of fields that are inconsistent with one another such that at least one of the plurality of fields is incorrect, but where it is not possible to determine which of the plurality of fields is incorrect.

19. A method as claimed in claim 14 wherein the score assigned to each previously un-scored field is based on the number of groups that a field is in.

20. A method as claimed in claim 14 wherein the or each group of fields is identified by applying at least one rule to the data record, the or each rule being applied to a plurality of fields, failure of a rule meaning that at least one of the fields to which the rule has been applied is incorrect.

21. A method as claimed in claim 20 wherein the score assigned to each previously un-scored field is equal to 1 minus the ratio of the number of failed rules applied to that field to the total number of rules applied to that field.

22. A method as claimed in claim 20 wherein each rule is assigned a weight and the score assigned to each previously un-scored field is equal to 1 minus the ratio of the sum of the weights of failed rules applied to that field to the sum of the weights of all of the rules applied to that field.

23. A method as claimed in claim 14 wherein the score assigned to the data record is based on the sum of the scores for each field.

24. A method as claimed in claim 14 wherein each field is assigned a weight, and the score assigned to the data record is based on a ratio of the sum of the score for each field multiplied by its respective weight to the sum of the weights for all of the fields in the data record.

25. A method of quantifying the quality of a data record comprising a plurality of fields, each field for containing a data item, the method comprising:
applying at least one plural rule to the data record and recording a result, the or each plural rule being applied to a plurality of fields and failure of a plural rule meaning that at least one of the data items in the fields to which that plural rule has been applied is incorrect;
calculating a record score for the data record based upon the result of applying the or each plural rule to the data record, the record score indicating the quality of the data record.

26. A method as claimed in claim 25 further comprising, before applying the or each plural rule, applying at least one singular rule to the data record and recording a result, the or each singular rule being applied to a single field and failure of a singular rule meaning that a data item in the field to which that singular rule has been applied is incorrect, and wherein the record score is additionally based on the results of applying the or each singular rule to the data record.

27. A method as claimed in claim 26 further comprising ignoring a plural rule that is to be applied to a field which has failed a singular rule.

28. A method as claimed in claim 26 further comprising:
replacing a data item in a field that has failed a singular rule with a “Null” value; and
ignoring a plural rule that is to be applied to a field which contains a “Null” value.

29. A method as claimed in claim 25 further comprising calculating a field score for each field based upon the results of applying the or each plural rule to the data record, the record score being calculated based upon the field scores.

30. A method as claimed in claim 29 wherein the field score for a field is calculated based on a ratio of the number of failed plural rules applied to that field to the total number of plural rules applied to that field.

31. A method as claimed in claim 29 wherein each plural rule has an associated weight, and the field score for a field is calculated based on a ratio of the sum of the weights of failed plural rules applied to that field to the total sum of the weights of plural rules applied to that field.

32. A method as claimed in claim 25 wherein the record score is calculated depending upon how many plural rules fail.

33. A method as claimed in claim 25 wherein if a field does not contain a data item, a plural rule to be applied to a data item in that field is ignored.

34. A method as claimed in claim 25 wherein there are a plurality of plural rules, each plural rule having an associated weight indicating the relative importance of the plural rule.

35. A method as claimed in claim 25 wherein the result of applying a plural rule is one of success or failure.

36. A method as claimed in claim 25 wherein the or each plural rule defines a condition that should be true when comparing values of the data items in the plurality of fields to which the plural rule is applied.

37. A method as claimed in claim 36 wherein the condition is that a value of a data item in one field should be greater than a value of a data item in another field.

38. A method as claimed in claim 36 wherein the condition is that a value of a data item in one field should be consistent with a value of a data item in another field.

39. A computer program product stored on a computer readable medium, the computer program product for running on a processor and for causing the processor to calculate a score indicating the quality of a data record, the data record comprising a plurality of fields, the computer program product comprising:
code for applying at least one critical rule to the data record, the or each critical rule to identify an individual field that is incorrect;
code for assigning a field score to the or each identified individual field;
code for applying at least one regular rule to the data record, the or each regular rule to identify a group of at least two fields where at least one field in the group is incorrect; and
code for assigning a field score to any previously un-scored fields based upon whether the previously un-scored field is in an identified group of fields.

40. A computer system comprising a processor and a memory, the memory for storing a data record comprising a plurality of fields, at least one critical rule and at least one regular rule, the processor arranged to:
apply the or each critical rule to the data record in order to identify an individual field that is incorrect;
assign a field score to the or each identified individual field;
apply the or each regular rule to the data record in order to identify a group of at least two fields where at least one field in the group is incorrect;
assign a field score to any previously un-scored fields based upon whether the previously un-scored field is in an identified group of fields; and
store the field scores in the memory.
